(19) United States
(12) Patent Application Publication
(10) Pub. No.: US 2024/0362488 A1
(43) Pub. Date: Oct. 31, 2024

(54) BIG DATA ANALYSIS SYSTEM FOR ENGINE QUALITY DETECTION AND PREDICTION

(71) Applicant: GUANGXI UNIVERSITY, Nanning (CN)

(72) Inventors: Ying YANG, Nanning (CN); Kai YANG, Nanning (CN); Shuaihu YANG, Nanning (CN); Min FENG, Nanning (CN)

(73) Assignee: GUANGXI UNIVERSITY, Nanning (CN)

(21) Appl. No.: 18/641,446

(22) Filed: Apr. 22, 2024

(30) Foreign Application Priority Data
Apr. 27, 2023 (CN) 2023104762499

(51) Int. Cl. G06N 3/084

(52) U.S. Cl. CPC G06N 3/084

(57) ABSTRACT

The invention discloses a big data analysis system for engine quality detection and prediction, comprising an oil acquisition module for collecting oil in an engine; an oil analysis module for obtaining spectral data, ferrographic data, and physicochemical data of the oil; a data fusion module for fusing the spectral data, ferrographic data and physicochemical data based on a fuzzy logic and a D-S evidence theory to obtain oil fusion data; an oil prediction module for constructing an oil prediction model, training the oil prediction model based on the oil fusion data, and predicting the oil in the engine based on a trained oil prediction model to obtain oil prediction data; a quality detection module connected with the oil prediction module for obtaining a wear degree of the engine and completing a quality prediction of the engine based on the oil prediction data.

### TECHNICAL FIELD

The invention belongs to the field of engine quality detection technology, in particular to a big data analysis system for engine quality detection and prediction.

### BACKGROUND ART

At present, mechanical equipment is developing towards large-scale, continuous, high-speed, precision, systematization, and automation, the structure of the equipment is becoming more and more complex, which brings new problems to equipment management and maintenance. Therefore, the modernization of the production process puts forward higher requirements for the reliability of equipment, and the economy of equipment maintenance and replacement. The engine of the machine equipment is extremely prone to wear failure because it is often in harsh and complex environments such as high temperature, high speed, and high load during operation. In the quality inspection system of the engine, the main defects of the preventive periodic maintenance and the damage re-maintenance system are the coexistence of under-maintenance and over-maintenance, as a result, the engine either works with ‘disease’ or is repaired when there is no ‘disease’. Obviously, such quality inspection methods can no longer meet the requirements of lean production in enterprises.

In the process of quality inspection, wear trend prediction is an important link, in the existing monitoring technology, ferrographic analysis technology is the most effective method to monitor wear conditions and diagnose wear faults. However, since quantitative ferrography reading can only be used to indirectly characterize the wear behavior of the engine, and the characterization of data cannot accurately predict the wear trend of the engine, it cannot provide accurate information for the future monitoring and maintenance of the engine.

Therefore, it is urgent to propose a big data analysis system for engine quality detection and prediction, which integrates multiple data representations that affect engine quality detection and realizes intelligent prediction of engine quality, which is of great significance for the technical maintenance of the machine.

### SUMMARY

The purpose of the invention is to disclose a big data analysis system for engine quality detection and prediction to solve the problems existing in the above-existing technologies.

In order to achieve the above purpose, the invention discloses a big data analysis system for engine quality detection and prediction, comprising:
an oil acquisition module for collecting oil in an engine;
an oil analysis module connected with the oil acquisition module for obtaining spectral data, ferrographic data, and physicochemical data of the oil;
a data fusion module connected with the oil analysis module for fusing the spectral data, ferrographic data, and physicochemical data based on a fuzzy logic and a D-S evidence theory to obtain oil fusion data;
an oil prediction module connected with the data fusion module for constructing an oil prediction model, training the oil prediction model based on the oil fusion data, and predicting the oil in the engine based on a trained oil prediction model to obtain oil prediction data;
a quality detection module connected with the oil prediction module for obtaining a wear degree of the engine and completing a quality prediction of the engine based on the oil prediction data.

Optionally, the oil analysis module comprises:
a spectral analysis unit for obtaining the spectral data of the oil based on a spectral analyzer;
a ferrographic analysis unit for constructing and training an oil wear particle detection model, and obtaining a shape, size, and type of all wear particles in the oil based on a trained oil wear particle detection model, where the shape, size, and type of all oil wear particles are the ferrographic data of the oil;
a physicochemical analysis unit for determining physicochemical indexes of the oil to obtain physicochemical data of the oil.

Optionally, the ferrographic analysis unit comprises a wear particle image acquisition sub-unit, the wear particle image acquisition sub-unit is used for constructing a wear particle detection model based on a U-net network to obtain a ferrographic image, and then training the wear particle detection model based on the ferrographic image to obtain a trained wear particle detection model; obtaining a wear particle image by inputting a ferrographic image to be detected into the trained wear particle detection model for recognition.

Optionally, the ferrographic analysis unit also comprises a wear particle contour detection sub-unit, the wear particle contour detection sub-unit is used for performing edge detection on the wear particle image based on a Canny operator to obtain an edge contour of the wear particle image, thereby extracting the shapes, sizes, and types of all wear particles.

Optionally, the data fusion module comprises:
a credibility acquisition unit for obtaining evidence credibility and rule credibility corresponding to the spectral data, ferrographic data, and physicochemical data based on a fuzzy membership function;
a data fusion unit for obtaining a corresponding comprehensive confidence based on evidence credibility and rule credibility corresponding to the spectral data, ferrographic data, and physicochemical data respectively, and completing a data fusion based on the comprehensive confidence.

Optionally, the oil prediction module comprises a prediction model construction unit, the prediction model construction unit is used for constructing the oil prediction model based on a genetic algorithm and a BP network, and training the oil prediction model based on the oil fusion data to obtain a trained oil prediction model.

Optionally, the oil prediction module also comprises a prediction model test unit, the prediction model test unit is used for obtaining the oil prediction data based on the trained oil prediction model, and comparing the oil prediction data with actual oil data based on an error backpropagation algorithm, when an error is greater than a preset threshold, the oil prediction model is continuously trained, and a loop of is repeated until the error meets the preset threshold, and a final trained oil prediction model is output.

The technical effect of the invention is as follows:

Compared with the existing technology, when the quality of the engine is tested and predicted, the invention obtains three kinds of oil analysis data: the spectral analysis data, ferrographic analysis data, and physicochemical analysis data. Then, the fuzzy logic and D-S evidence theory are used to fuse the extracted oil analysis data, and the oil prediction model is trained according to the fusion data to realize the prediction of the engine oil. Finally, the quality diagnosis of engine wear is realized based on the prediction data of oil.

The invention can implement state repair for the fault precursor of the engine, which can greatly reduce the maintenance workload and maintenance cost, and greatly reduce the maintenance cost.

### BRIEF DESCRIPTION OF THE DRAWINGS

The FIGURE that forms part of this invention is used to provide further understanding of this invention. The schematic embodiment and description of this invention are used to explain this invention and do not constitute an improper qualification of this invention. In the attached FIGURE:

FIG. 1 is a schematic diagram of the structure of the big data analysis system for engine quality detection and prediction in the embodiment of the invention.

### DETAILED DESCRIPTION OF THE EMBODIMENTS

It should be noted that the embodiment in this invention and the characteristics of the embodiment can be combined without conflict, this invention is explained in detail by combining the attached FIGURE and embodiment in the following.

It should be noted that the steps shown in the flow chart attached to the FIGURE can be executed in a computer system such as a set of computer-executable instructions, and although the logical order is shown in the flow chart, in some cases, the steps shown or described can be executed in a different order from here.

### Embodiment One

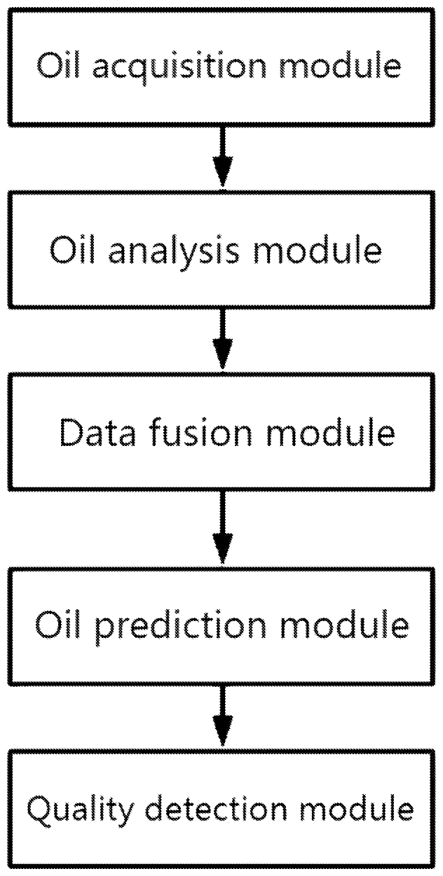

As shown in FIG. 1, this embodiment provides a big data analysis system for engine quality inspection and prediction, comprising:
an oil acquisition module for collecting the oil in the engine;
an oil analysis module connected with the oil acquisition module for obtaining the spectral data, ferrographic data, and physicochemical data of the oil;
a data fusion module connected with the oil analysis module for fusing the spectral data, ferrographic data, and physicochemical data based on the fuzzy logic and the D-S evidence theory to obtain the oil fusion data;
an oil prediction module connected with the data fusion module for constructing the oil prediction model, training the oil prediction model based on the oil fusion data, and predicting the oil in the engine based on the trained oil prediction model to obtain the oil prediction data;
a quality detection module connected with the oil prediction module for obtaining the wear degree of the engine and completing the quality prediction of the engine based on the oil prediction data.

In a possible implementation case, the oil analysis module comprises:
a spectral analysis unit for obtaining the spectral data of the oil based on the spectral analyzer;
a ferrographic analysis unit for constructing and training the oil wear particle detection model, and obtaining the shape, size, and type of all wear particles in the oil based on the trained oil wear particle detection model, where the shape, size, and type of all oil wear particles are the ferrographic data of the oil;
a physicochemical analysis unit for determining physicochemical indexes of the oil to obtain the physicochemical data of the oil.

The ferrographic analysis unit comprises a wear particle image acquisition sub-unit, the wear particle image acquisition sub-unit is used for constructing the wear particle detection model based on the U-net network to obtain the ferrographic image, and then training the wear particle detection model based on the ferrographic image to obtain the trained wear particle detection model; obtaining the wear particle image by inputting the ferrographic image to be detected into the trained wear particle detection model for recognition.

The ferrographic analysis unit also comprises a wear particle contour detection sub-unit, the wear particle contour detection sub-unit is used for performing the edge detection on the wear particle image based on the Canny operator to obtain the edge contour of the wear particle image, thereby extracting the shape, size, and type of all wear particles.

The ferrographic analysis unit of this implementation case can precipitate and detect wear particles in the size range of 1-250 um from the oil sample, and the wear particles in this range can reflect the wear characteristics of the machine in the best way, so the wear changes of the machine can be judged in time and accurately.

This implementation case adopts the Canny operator to detect the edge of the image, which has the characteristics of a low false detection rate, high positioning accuracy, and fine edge pixels detected. Where the edge detection using the Canny operator can obtain the edge pixels, and then combine with the wear particle image contour identified by the oil wear particle detection model, the overlapping wear particle image region can be identified by the image fusion of the Canny operator, and the oil wear particle detection model. Based on the contour of the wear particle image detected by the U-net network, cutting the overlapping wear particle image area can obtain a more accurate wear particle contour, and then effectively extract the shapes, sizes, and types of all wear particles on the image.

In a possible implementation case, the data fusion module comprises:
a credibility acquisition unit for obtaining the evidence credibility and rule credibility corresponding to the spectral data, ferrographic data, and physicochemical data based on the fuzzy membership function; a data fusion unit for obtaining the corresponding comprehensive confidence based on the evidence credibility and rule credibility corresponding to the spectral data, ferrographic data, and physicochemical data respectively, and completing the data fusion based on the comprehensive confidence.

As a specific implementation example, this implementation example constructs a fuzzy logic membership function model, and uses the fuzzy logic membership function model to determine the evidence credibility of the spectral data, the evidence credibility of the ferrographic data, and the evidence credibility of the physicochemical analysis data. The respective rule credibility is established according to the evidence credibility of each analysis data. In order to calculate the evidence credibility of each oil analysis data, the oil analysis data is blurred, and the blurred value is set as the evidence credibility of the data. Based on a large amount of expert knowledge and experimental data, the corresponding rule credibility is established according to each piece of evidence, comprising but not limited to the rules of ‘wear’ and ‘oil analysis data’, ‘fault’, and ‘oil analysis data’, and ‘normal’ and ‘oil analysis data’. According to the evidence credibility of each oil analysis data and the rule credibility of the oil analysis data, the comprehensive confidence of the oil analysis data is established, and then the fusion result of the oil analysis data is calculated according to the comprehensive confidence of multiple oil analysis data.

In a possible implementation case, the oil prediction module comprises a prediction model construction unit, the prediction model construction unit is used for constructing the oil prediction model based on a genetic algorithm and the BP network, and training the oil prediction model based on the oil fusion data to obtain the trained oil prediction model.

In a possible implementation case, the oil prediction module also comprises a prediction model test unit, the prediction model test unit is used for obtaining the oil prediction data based on the trained oil prediction model, and comparing the oil prediction data with actual oil data based on the error back propagation algorithm, when the error is greater than the preset threshold, the oil prediction model is continuously trained, and the loop of is repeated until the error meets the preset threshold, and the final trained oil prediction model is output.

Compared with the existing technology, when the quality of the engine is tested and predicted, the invention obtains three kinds of oil analysis data: the spectral analysis data, ferrographic analysis data, and physicochemical analysis data. Then, the fuzzy logic and D-S evidence theory are used to fuse the extracted oil analysis data, and the oil prediction model is trained according to the fusion data to realize the prediction of the engine oil. Finally, the quality diagnosis of engine wear is realized based on the prediction data of oil. This implementation example can implement condition-based repair for the engine fault precursors, which can greatly reduce the maintenance workload and maintenance cost, and greatly reduce the maintenance cost.

The above is only a better specific embodiment of this invention, but the scope of protection of this embodiment is not limited to the implementation methods, any changes or replacements that can be easily imagined by technical personnel familiar with this technical field within the technical scope disclosed in this embodiment should be covered by the scope of protection of this embodiment. Therefore, the scope of protection of this embodiment should be based on the scope of protection of claims.

What is claimed is:

1. A big data analysis system for engine quality detection and prediction, comprising:
an oil acquisition module for collecting oil in an engine; an oil analysis module connected with the oil acquisition module for obtaining spectral data, ferrographic data, and physicochemical data of the oil; a data fusion module connected with the oil analysis module for fusing the spectral data, ferrographic data, and physicochemical data based on a fuzzy logic and a D-S evidence theory to obtain oil fusion data; an oil prediction module connected with the data fusion module for constructing an oil prediction model, training the oil prediction model based on the oil fusion data, and predicting the oil in the engine based on a trained oil prediction model to obtain oil prediction data; a quality detection module connected with the oil prediction module for obtaining a wear degree of the engine and completing a quality prediction of the engine based on the oil prediction data.

2. The big data analysis system for engine quality detection and prediction according to claim 1, wherein the oil analysis module comprises: a spectral analysis unit for obtaining the spectral data of the oil based on the spectral analyzer; a ferrographic analysis unit for constructing and training an oil wear particle detection model, and obtaining a shape, size, and type of all wear particles in the oil based on a trained oil wear particle detection model, where the shape, size, and type of all oil wear particles are the ferrographic data of the oil; a physicochemical analysis unit for determining physicochemical indexes of the oil to obtain physicochemical data of the oil.

3. The big data analysis system for engine quality detection and prediction according to claim 2, wherein the ferrographic analysis unit comprises a wear particle image acquisition sub-unit, the wear particle image acquisition sub-unit is used for constructing a wear particle detection model based on a U-net network to obtain a ferrographic image, and then training the wear particle detection model based on the ferrographic image to obtain a trained wear particle detection model; obtaining a wear particle image by inputting a ferrographic image to be detected into the trained wear particle detection model for recognition.

4. The big data analysis system for engine quality detection and prediction according to claim 3, wherein the ferrographic analysis unit also comprises a wear particle contour detection sub-unit, the wear particle contour detection sub-unit is used for performing edge detection on the wear particle image based on a Canny operator to obtain an edge contour of the wear particle image, thereby extracting shapes, sizes, and types of all wear particles.

5. The big data analysis system for engine quality detection and prediction according to claim 1, wherein the data fusion module comprises: a credibility acquisition unit for obtaining evidence credibility and rule credibility corresponding to the spectral data, ferrographic data, and physicochemical data based on a fuzzy membership function;
a data fusion unit for obtaining a corresponding comprehensive confidence based on evidence credibility and rule credibility corresponding to the spectral data, ferrographic data, and physicochemical data respectively, and completing a data fusion based on the comprehensive confidence.

6. The big data analysis system for engine quality detection and prediction according to claim 1, wherein the oil prediction module comprises a prediction model construction unit, the prediction model construction unit is used for constructing the oil prediction model based on a genetic algorithm and a BP network and training the oil prediction model based on the oil fusion data to obtain a trained oil prediction model.

7. The big data analysis system for engine quality detection and prediction according to claim 6, wherein the oil prediction module also comprises a prediction model test unit, the prediction model test unit is used for obtaining oil prediction data based on the trained oil prediction model, and comparing the oil prediction data with actual oil data based on an error backpropagation algorithm, when an error is greater than a preset threshold, the oil prediction model is continuously trained, and a loop of is repeated until the error meets the preset threshold, and a final trained oil prediction model is output.
